(19) United States
(12) Patent Application Publication
(10) Pub. No.: US 2010/0218101 A1
(43) Pub. Date: Aug. 26, 2010

(54) USER HEALTH STATUS

(75) Inventors: Timothy O'Shaughnessy, Washington, DC (US); Edward Frederick, Washington, DC (US)

Correspondence Address: FISH & RICHARDSON P.C., P.O. BOX 1022, MINNEAPOLIS, MN, 55440-1022, US

(73) Assignee: Waterfront Media, Inc., Brooklyn, NY (US)

(21) Appl. No.: 12/641,667

(22) Filed: Dec. 18, 2009

Related U.S. Application Data
(63) Continuation of application No. PCT/US2008/067489, filed on Jun. 19, 2008.
(60) Provisional application No. 60/945,008, filed on Jun. 19, 2007.

(51) Int. Cl. G06F 3/01

(52) U.S. Cl. 715/733

(57) ABSTRACT

A method includes providing a first user with an ability to indicate a health status and receiving an indication of the health status. The method also includes assigning a health status and associated task requests to the first user into a record and providing the health status and task requests as corresponding to the first user. The method further includes enabling other users to select from one or more of the task requests and receiving an indication that a second user has selected a first task request associated with the health status. In addition, the method includes assigning the first task request associated with the health status and providing, to the other users, the health status as corresponding to the first user and the assigned first task request associated with the health status as assigned to the second user.

### CROSS-REFERENCE TO RELATED APPLICATIONS

This application is a continuation application of and claims priority from International Application No. PCT/US2008/067489, with an international filing date of Jun. 19, 2008, which claims priority from U.S. Provisional Application No. 60/945,008, filed Jun. 19, 2007. The contents of the prior applications are incorporated in their entirety herein by reference.

### TECHNICAL FIELD

This application relates to health status, and more particularly to health status indications directed to users within Internet based user networks.

### BACKGROUND

Users may interact over the Internet through social networking sites.

### SUMMARY

According to one general aspect, a computer-implemented method enables a user of a social networking website to present, to other users, a health status and multiple task requests such that another user may select a task request and view the selection of task requests of other users. The method includes providing a first user accessing a social networking website over the Internet and through a web-browser with an ability to indicate a health status and receiving, from the first user, an indication of the health status and a selection of multiple task requests to be associated with the health status. The method also includes updating, based on the received indication and selection from the first user, a profile of the first user within the social networking website stored in a user profile data structure to include the indicated health status and task requests and providing, to other users accessing the social networking website over the Internet and through a web-browser, the profile of the first user as including the health status and task requests. The method further includes enabling the other users to select from one or more of the task requests so that other users may perceive task requests that have been assigned to users and to select an unassigned task request and receiving, from a second user within the other users, an indication that the second user has selected a first task request associated with the health status within the one or more task requests. In addition, the method includes assigning, based on the received indication from the second user, the first task request associated with the assigned health status to the second user and updating the assignment of the first task request associated with the assigned health status as referenced within the user profile data structure. Finally, the method includes providing, to the other users associated with the first user accessing the first user's profile within the social networking website, the health status as assigned to the first user and the first task request associated with the assigned health status as assigned to the second user.

According to a second general aspect, a computer-implemented method provides task requests associated with a health status of a user such that the task requests may be assigned to one or more other users. The method includes providing a first user with an ability to indicate a health status and receiving, from the first user, an indication of the health status. The method also includes assigning, based on the received indication from the first user, a health status and associated task requests to the first user into a record and storing the assigned record of the health status and the task requests. The method further includes providing, to other users, the health status and task requests as corresponding to the first user and enabling the other users to select from one or more of the task requests so that other users may perceive task requests that may be selected. In addition, the method includes receiving, from a second user within the other users, an indication that the second user has selected a first task request associated with the health status within the one or more task requests and assigning, based on the received indication from the second user, the first task request associated with the health status. Finally, the method includes storing the assignment of the first task request associated with the health status and providing, to the other users, the health status as corresponding to the first user and the assigned first task request associated with the health status as assigned to the second user.

The method can include other features. For example, assigning the health status and associated task requests to the first user into a record may include assigning multiple task requests which each represent a portion of a predetermined plan of care for the health status into the record. Providing the health status and task requests as corresponding to the first user may include providing, to other users viewing a social networking profile of the first user, the health status and task requests as features within the social networking profile of the first user. Enabling the other users to allocate themselves one or more of the task requests may include enabling the other users viewing the social networking profile of the first user to view a populated list of task requests and select, from the populated list, one or more of the task requests for allocation. Providing, the health status as corresponding to the first user and the assigned first task request associated with the health status as assigned to the second user may include providing, to the other users viewing a social networking profile of the first user, the health status as corresponding to the first user as a first feature within a first viewable portion of the social networking profile of the first user and the assigned first task request associated with the health status as assigned to the second user as a second feature within a second viewable portion of the social networking profile of the first user. Providing, the health status as corresponding to the first user and the assigned first task request associated with the health status as assigned to the second user may include providing, to other users viewing a social networking profile of the second user, the assigned first task request associated with the health status as assigned to the second user as a feature with the social networking profile of the second user.

The method may also include providing the first user the ability to indicate one or more task requests associated with the indicated health status, wherein receiving the indication of the health status includes receiving, from the first user, the indication of the health status and the indication of the one or more task requests associated with the health status. Receiving the indication of one or more task requests associated with the health status may consist of receiving the indication of one or more task requests concurrently with or after receiving the indication of the health status. Receiving the indication of the one or more task requests associated with the health status may include receiving the indication of the one or more task requests concurrently with and assigned to the indication of the health status.

Providing the first user with the ability to indicate the health status may include providing, as functionality to a user of a social networking website, the ability to indicate the health status to be associated with the likeness of the first user within the social networking website. Assigning task requests to the first user may include determining that the one or more task requests should be assigned to the first user based on the indicated health status. Assigning task requests to the first user may include determining that the one or more task requests should be assigned to the first user based on one or more aspects of a first user's profile other than health status.

Implementation may include methods, systems, and devices with similar features. Also, implementations of the desired techniques may include hardware or computer software on a computer accessible medium. The details of one or more implementations are set forth in the accompanying drawings and the description below. Other features will be apparent from the description and drawings, and the claims.

### DESCRIPTION OF DRAWINGS

FIG. 1 is a graphical user interface including an initial health status indication.

FIG. 2 is a graphical user interface including an updated health status indication.

FIG. 3 is a graphical user interface including an added favor request.

FIG. 4 is a graphical user interface including a request for a user to take a favor request.

FIG. 5 is a graphical user interface including a taken favor request.

FIG. 6 is a graphical user interface including a health status indication removal option.

FIG. 7 is a system for providing health status functionality.

FIG. 8 is a data structure of enabling health status functionality.

FIG. 9 is a flow chart of a process for providing health status functionality.

FIG. 10 is a flow chart of a process for providing health status functionality using third party information providers.

### DETAILED DESCRIPTION

Users of networking sites (e.g., social networking sites such as the “Facebook” or “MySpace” networks) have an ability to track changes in status across users or groups of users. For example, a user of a networking site may enter personal information which may, in turn, be distributed or viewed by other users. Accordingly, an indication of a user's health or status (i.e., a “health status”) may be entered by a user or determined for the user, and the health status may be presented to other users. Entering or updating a health status may prompt messages or notices to be delivered to other users or groups of users.

The messages or notices may include functionality directed to the entered or updated health status. For example, a notice that a user has a cold may be accompanied with a request for one or more users to bring over chicken soup. The request may be accepted by another user. The notice that the user has a cold and the acceptance of the request to bring over chicken soup by the other user may be viewable to other users on the network.

Also, health status information may generate data used by third parties to provide additional functionality or information relevant to the health status. For example, a user entering a health status of “a cold” may cause data to be sent to a third party detailing the user's selected health status as well as context information, such as, for example, location, age, sex, previous health statuses, etc. The third party may use the health status and/or the context information to provide additional relevant functionality. For example, if a user enters a health status of “a cold” outside of a cold season but in a geographical location currently with a high pollen count, the third party may determine that the user may have incorrectly identified the health status, and send a notice to the user. The third party also may send additional information detailing the cause or cure of a health status, detailing suggested medical providers, providing access to diagnosing software, or other information.

The functionality enabling the health status information and associated features may be provided by a host system of a social networking site or by third parties. For example, in one implementation, a social networking site enables third parties to provide functionality modules configured to enable the third party's system to provide functionality on the social networking system. In one example, a third party provides a health status module to a social networking system. The health status module directs the social network to offer health status functionality. When a user of the social network utilizes the offered functionality (e.g., indicates they are ill), the social network sends an indication to the third party computer system which provided the module. The third party computer system determines the appropriate response and forwards it to the social network. The social network then generates appropriate responses which are presented to various users.

Although the below discussion generally refers to health status information as used in the context of a social networking site, the health status information may be employed in other contexts. For example, in one implementation, the health status information is used in a hospital setting. In particular, hospital patients who are able to interact with a computer system are enabled to provide and update their perceived health status. The hospital patients and medical professionals may add, alter, or accept responsibility for medical tasks. In one implementation, some functionality is hidden from the hospital patient. For example, in one implementation, the hospital patient is enabled to alter their own status (e.g., from “feeling okay”, to “in-pain”) while only medical professionals are enabled to request and assign tasks (e.g., “take the patient's blood pressure” or “clean wounds this evening”) that may be assigned to only other medical professionals.

In another implementation not necessarily within a hospital, a social networking website allows the assignment of task request to fulfill a plan of care. For example, in order to treat or cope with a particular ailment, a doctor may assign a number of tasks to be fulfilled. A user of the social networking website may setup multiple tasks which each represent a portion of the plan of care. Thereafter, individuals may select a particular task to help or take responsible with in fulfilling the plan of care. Although examples below may, for simplicity, refer to simple tasks (e.g., “bring chicken soup”), the tasks may be a specific portion for a plan of care (e.g., “take patient to the days second dialysis treatment).

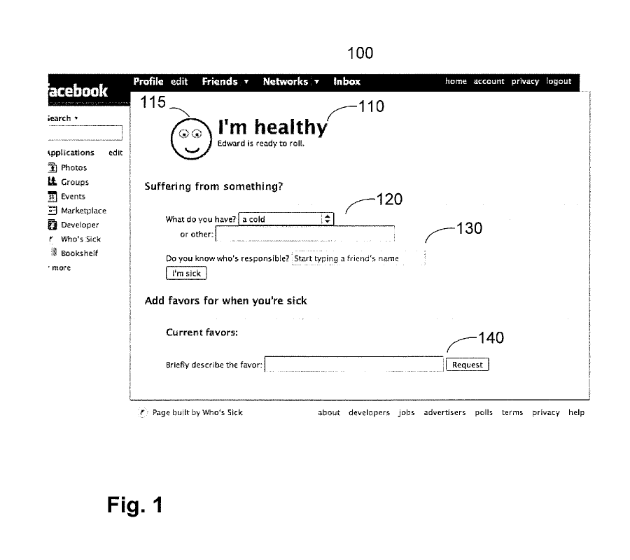

Referring to FIG. 1, an exemplary graphical user interface (GUI) 100 includes an initial health status indication. The initial health status indication enables the user to enter a health status, responsible user, and to make requests for favors. The GUI 100 includes a current health status indication 110. As shown, the health status indication specifies “I'm Healthy” as a default health status to be shown when no other status is indicated. The health status indication also includes a status icon 115 which is associated with the health status indication 110. The shown smiley face status icon 115 is related to the “I'm Healthy” health status indication 110.

A user may enter or update a health status through use of a health status input option 120. The user may select a predetermined health status (such as “a cold” as shown), or may manually enter a new health status. The predetermined list may be generated by the networking system or a third party system based on a user's (or group of users') context or history. For example, if a third party has determined that there is a high incidence of cold and flu in the user's location, the user may be presented a predetermined list with cold and flu as options near the top of the list. Alternatively, the predetermined list may be personalized based on a user's history of health statuses or based on the health statuses of the user's associated friends or groups. After entering a new or updated health status, the current health status indication 110 and the status icon 115 may change to reflect the new or updated health status.

Entering a health status or selecting accompanying options may generate messages or notices to be sent to other users or data to be generated and sent to third parties. For example, if a user enters a health status of “a cold,” the user's friends on a friend list may be sent an indication of the entered health status. Also, entering the new or updated health status may result in information being sent to a third party which tracks or enables health status indications.

A responsible party input option 130 enables a user to specify who (if any) other user is believed to have been responsible or contributed to the health status. For example, a user with a cold may have recently interacted with a friend who is recovering from a cold. The user may determine that he/she likely caught their cold from their friend, and accordingly, may use the responsible party input option 130 to assign responsibility to the friend. Also, a request favor input option 140 enables a user to request one or more favors from other users. The user may enter a specific request for display to other users along with display of the user's health status. Other users may specify that they will take responsibility for the request. Various implementations may enable one or multiple users to take responsibility for the same request.

When selecting the responsible party with the responsible party input option 130, the user may be presented with a pre-populated list that takes into account the user's context as well as that of other associated lists. For example, if within an associated group of friends, one user has a health status of “a cold” or has been listed as the responsible party for a cold, the user may be determined to belong at the top of an automatically generated list of responsible parties to be presented to a user interacting with the responsible party input option 130.

Although the above discussion generally refers to health status indications and task requests as manually entered by a user with the health status input option 120 and the request favor input option 140, the user's health status may be automatically determined or suggested through other information. For example, data generated by a camera (e.g., a webcam) that is able to be used in automatically determining traits (e.g., bags under eyes, color change, etc.) may be used to change a status. Further, in a hospital setting, data from medical information gathering devices may be used to add or change a health status. For example, if a user's heart rate monitor measured an abnormal heart rate, the measuring system may determine to change the health status from “normal” to “elevated heart rate.” In another example, if the user's heart rate monitoring ceases to provide data (e.g., if the sensor is removed), the system may change the health status from “normal” to “unknown” and may generate and/or assign a task to investigate the cessation of data.

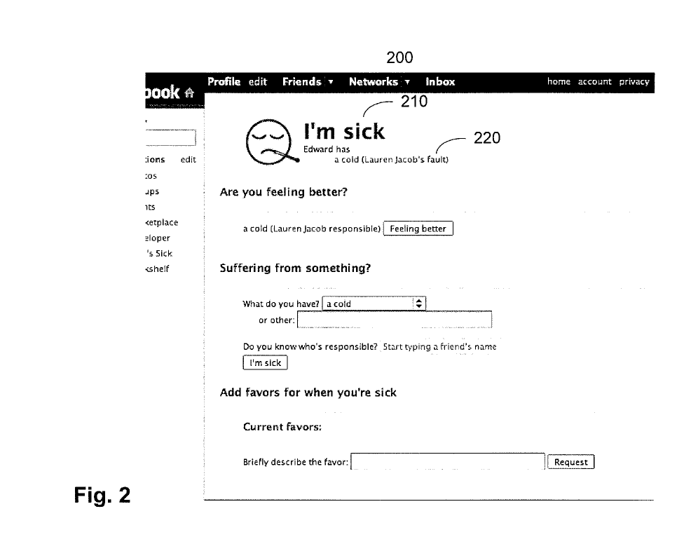

Referring to FIG. 2, an exemplary GUI 200 includes an updated health status indication. The GUI 200 may be rendered in response to the user interacting with the GUI 100 of FIG. 1 to input a health status of “a cold” with the health status input option 120 and a specific user with the response party input option 130. As shown, the user's health status indication 210 has changed to show an icon reflective of a sick user and to state “I'm sick.” The health status indication gives further detail to specify that the illness is a cold, and specifies the user whom is believed to be responsible 220.

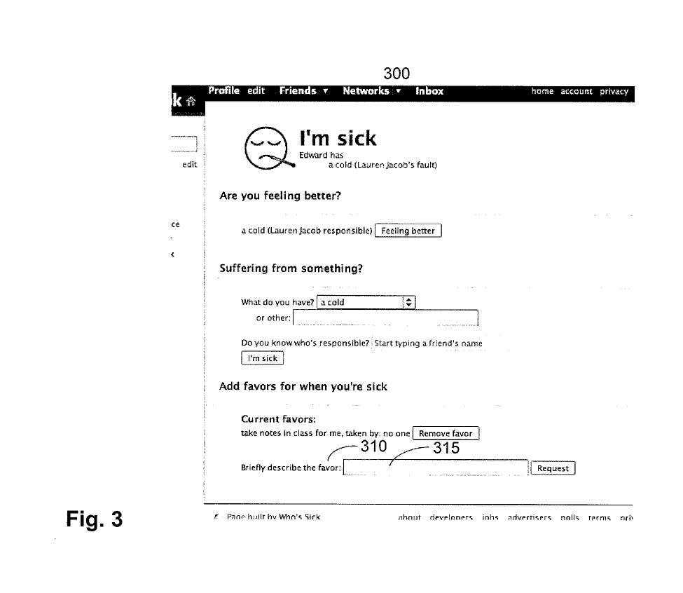

Referring to FIG. 3, an exemplary GUI 300 includes an added “favor request.” The GUI 300 may be rendered in response to the user interacting with the GUI 100 of FIG. 1 to input a request of “take notes in class for me” with the request favor input option 140. As shown, the user's favor request 310 has been updated to include a request for someone to take notes. Other users may indicate that they will take the request (i.e., indicate that they will fulfill the request). As shown, no other users have taken the request 315. When a user selects to take a request, a message, reminder, or additional functionality within the networking system or within a third party may be triggered. For example, if a user takes a request to take notes at a specific time, a third party may be triggered to send a reminder email at a time shortly before the class. In other implementations, application enhanced requests may be tied to context based functionality provided by a third party. For example, in one implementation, if a second user takes a request to purchase cough medicine from a requesting first user, the third party may send the second user a list of nearby locations to procure the cough medicine. More specifically, when the second user takes responsibility to purchase cough medicine, an indication including the first and second users' identity, address, and contact information is sent to the third party. The third party then uses the received information to determine a map detailing directions from the second user's place of residence to nearby stores selling the medicine and then to the first user's place of residence. The third party also e-mails the map and remainders to the second user.

In various implementations, favor requests are automatically generated in response to an altered health status and may take into account the context of the user. For example, in one implementation, after a user enters a health status of “a cold,” task requests related to colds are automatically requested, such as “buy chicken soup” and “bring over hot tea.” In another example, the automatically generated task request is dependent on the user's context information. For example, the automatically generated task requests may include the user's address to specify “buy chicken soup and bring it over to 123 anyplace Ln. Apt. #111.” Further, automatically generated favor requests may include advertisements, coupons, or solicitations for services such as taxi rides, etc.

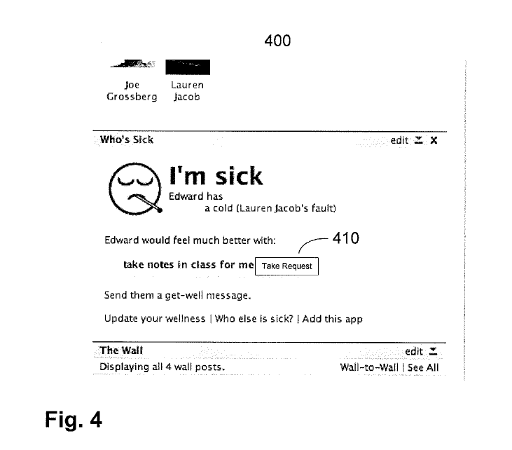

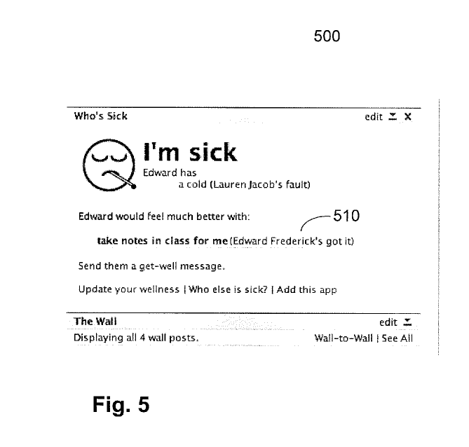

Referring to FIG. 4, an exemplary GUI 400 includes a request for a user to take a favor request. The GUI 400 may be rendered to a second user in response to the added favor request of GUI 300 of FIG. 3. In particular, the GUI 400 is requesting that the second user take a favor that has been requested by the sick user Edwards. The second user is presented with the option to take the request 410. If the second user takes the request, the sick user Edwards may be sent a message or notification detailing the second user's acceptance of the request. Also, the profile of the taking user may be updated to indicate the taking user has taken the request similarly to the indication of the sick user as shown in the GUI 500 of FIG. 5. The GUI 500 of FIG. 5 includes an example of a taken favor request. Specifically, the GUI 500 may be rendered to the user whom has taken the favor request requested by GUI 400 of FIG. 4 or other users. As shown by the taken request indication 510, the GUI 500 indicates that the viewing user has taken the favor that has been requested by the sick user Edwards. Although, as shown, the taking user is also Edwards, other users may take the request and be rendered the GUI 500.

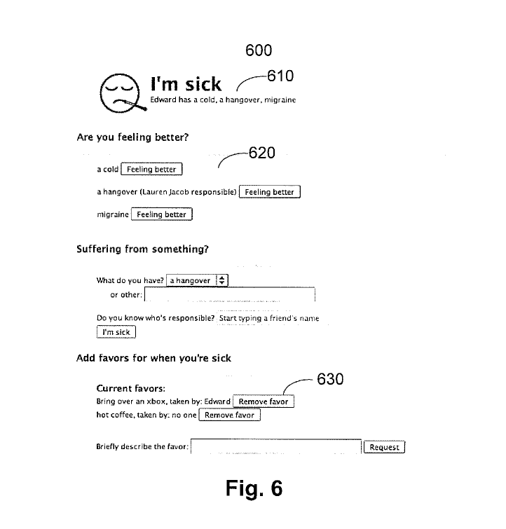

Referring to FIG. 6, an exemplary GUI 600 includes a health status indication removal option. The GUI 600 may be rendered in response to the user interacting with the GUI 100 of FIG. 1 to input health statuses of “a cold,” “a hangover,” and “a migraine” with the health status input option 120 and to input favor requests of “Bring over an xbox” and “hot coffee” with the favor request input option 130. Further, the user, Edwards, has taken the favor of “Bring over an xbox.” As shown, the user's health status indication 610 has been updated to include the three entered health status.

The user may selectively update one or more of the entered health indications by selecting a health status indication removal option 620. When activated, the health status indication removal option 620 removes a previously inputted health status, and the accompanying health status indication and a message or notice may be sent to other users. Further, in one implementation, favors requests are associated with specific ailments and when a health status indication removal option 620 is selected for an ailment associated with a favor request, the associated favor request is also removed. For example, if in the GUI 600, only the favor request of “hot coffee” is associated with health status indication of “a cold,” and the user selects the health status indication removal option 620 for the “a cold” health status, only the “hot coffee” favor request will be removed. Therefore, the user may selectively remove favor requests by selectively removing health status indications 610.

Additionally or alternatively, the user may selectively remove one or more favor requests through use of a favor request remove option 630. Selecting the favor request remove option 630 may remove the favor request for the user whether or not it has been taken by another user. For example, if the user no longer wishes the favor to be taken or has alternatively had the favor fulfilled, the user may select the favor request remove option 630 so other users will refrain from fulfilling the request.

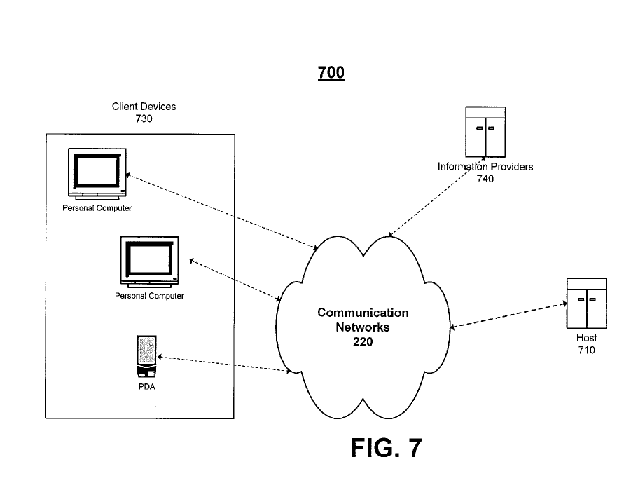

Referring to FIG. 7, a system 700 for providing health status functionality includes a host 710, communication networks 720, client devices 730, and information providers 740 (referred to above as “third parties). In the system 700, the host 710 receives requests to provide or interact with health status indications and other functionality from the client devices 730 through the communication networks 720. The host also may receive health related information or functionality from the information providers 740 through the communication networks 720. The host 710 may use the health related information or functionality when providing health status indications to the client devices 730.

Each of the client devices 730, the information providers 740, and the host 710 may be implemented by, for example, a general-purpose computer capable of responding to and executing instructions in a defined manner, a personal computer, a special-purpose computer, a workstation, a server, a device, a component, other equipment or some combination thereof capable of responding to and executing instructions. The client devices 730 and the information providers 740 may be configured to receive instructions from, for example, a software application, a program, a piece of code, a device, a computer, a computer system, or a combination thereof, which independently or collectively direct operations, as described herein. The instructions may be embodied permanently or temporarily in any type of machine, component, equipment, or storage medium that is capable of being delivered to the client devices 730 or the host 710.

The client devices 730 and the information providers 740 may include one or more devices capable of accessing, sending, or receiving content from the host 710. The client devices 730 may include a general-purpose computer (e.g., a personal computer (“PC”)) capable of responding to and executing instructions in a defined manner, a workstation, a notebook computer, a Personal Digital Assistant (“PDA”), a wireless phone, a component, other equipment, or some combination of these items that is capable of responding to and executing instructions.

In various implementations, the client devices 730 include one or more information retrieval software applications (e.g., a browser, a mail application, an instant messaging client, an Internet service provider client, a media player, a mobile location based services client, or routing application, or other integrated client) capable of receiving one or more data units. The information retrieval applications run on a general-purpose operating system and a hardware platform that includes a general-purpose processor and specialized hardware for graphics, communications and/or other capabilities. The information retrieval applications can include, for example, a web-browser configured to load websites through hyper-text markup language (HTML), JavaScript®, or other code. In one implementation, the client devices 730 includes a wireless telephone running a micro-browser application on a reduced operating system with general purpose and specialized hardware capable of operating in mobile environments. The client devices 730 may be configured to enable users to setup or update health status indications or to setup or interact with functionality related to health status indications.

The communication networks 720 include hardware and/or software capable of enabling direct or indirect communications between the client devices 730 and the host 710. As such, the communication networks 720 may include a direct link between the client devices 730 and the host 710, or it may include one or more networks or subnetworks between them (not shown). Each network or subnetwork includes, for example, a wired or wireless data pathway capable of carrying and receiving data. Examples of the delivery network include the Internet, the World Wide Web, a Wide Area Network (“WAN”), a Local Area Network (“LAN”), analog or digital wired and wireless telephone networks, radio, television, cable, satellite, and/or any other delivery mechanism for carrying data. In one implementation, the client devices 730 are computing devices in hospital rooms and the communication networks 720 is a WAN setup within the hospital to facilitate communication between the hospital room client devices 730 and a server running as the host 710 also within the hospital.

The host 710 and the information providers 740 include a general-purpose computer having a central processor unit (CPU), and memory/storage devices that store data and various programs such as an operating system and one or more application programs. Other examples of the host 710 and the information providers 740 include a workstation, a server, a special purpose device or component, a broadcast system, other equipment, or some combination thereof capable of responding to and executing instructions in a defined manner. The host 710 may be configured to store and process the health status indications to enable the creation of the GUIs or functionality within the GUIs of FIGS. 1-6.

The information providers 740 may include third party databases accessible by the host 710. For example, the information providers 740 may include database information maintained or supplemented by a third parties. For example, if a user of a client device 730 specifies a health status to the host 710, the host 710 may forward the health status and information associated with the user to the information provider 740. Then, the information provider 740, may send back to the host 710 additional information detailing the cause or cure of a health status, detailing suggested medical providers, providing access to diagnosing software, or other information or functionality. The host 710 may provide the received information and/or functionality to user's accessing a health status or user profile.

Also, the host 710 may enable information providers 740 to provide functionality modules configured to enable the information providers 740 to provide health status related functionality on the host 710. In one example, an information provider 740 provides a health status module to the host 710 which directs the host 710 to offer health status functionality. When a user of the host 710 utilizes the offered functionality (e.g., indicates they are ill), the host 710 sends an indication to the information provider 740 which provided the module. The information provider 740 determines the appropriate response and forwards it to the host 710. The host 710 then generates appropriate responses which are presented to one or more of the client devices 730.

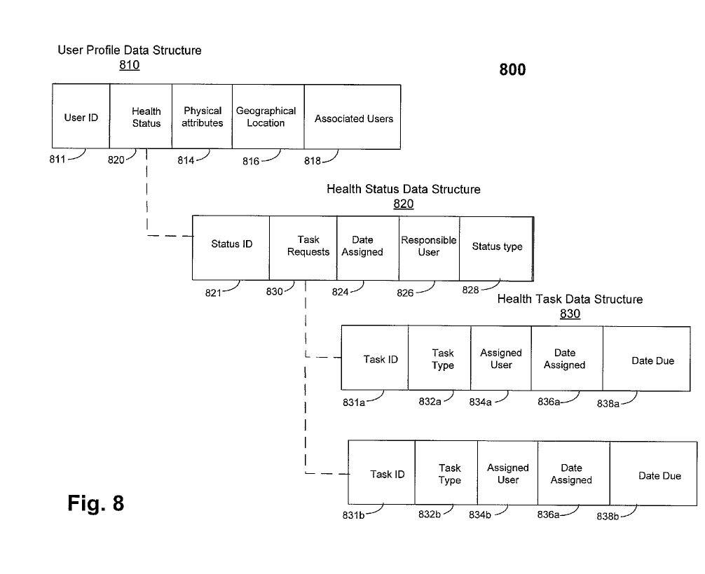

FIG. 8 is a data structure 800 enabling user profile and health status functionality. The data structure 800 of FIG. 8 may be stored by one or more of the elements of FIG. 7. In one implementation, the data structure 800 is stored in its entirety and accessed on the host 710 of the system 700 of FIG. 7. In another implementation, the data structure 800 is stored partly on the host 710 and partly on the information provider 740 and/or client device 730. As shown, the data structure 800 includes a user profile data structure 810 which includes a health status data structure 820 which includes one or more health task structures 830.

The user profile data structure 810 includes stored information about a user and includes data pertaining to a user ID 811, a health status 820, physical attributes 814, a geographical location 816, and a listing of associated users 818. In one implementation, the host 710 operates a social networking site and stores a user profile data structure 810 for each of the users of the social networking site. The user ID 811 uniquely specifies a particular user from among a group of users and may include, for example, a user name, a unique identification number, or an email address. The health status 820 includes an indication of an assigned health status and is described in more detail below. The physical attributes 814 data specifies characteristics of the user, such as, for example, age, sex, weight, hair color, or past health status information. The geographical location 816 data may include the address, longitude/latitude coordinates, or the location of the Internet protocol address of the user. The listing of associated users 818 may include one or more lists of other users related to the user. For example, the listing of associated users 818 may include user IDs 811 of other users that have been considered “friends” of the user.

The health status data structure 820 includes stored information about a health status including data pertaining to a status ID 821, one or more task requests 822, a date assigned 824, a responsible user 826, and a task type 828. The health status data structure may be created when a user indicates an altered health status. For example, referring to the GUI 100 of FIG. 1, when the user enters or updates a health status through use of a health status input option 120, a controlling host system 710 may create a health status data structure to be stored within (or have its location pointed to) the user's user profile data structure 810. The health status data structure 820 may be populated with data entered by the user (e.g., through use of features 120-140 of the GUI 100) and/or may be populated automatically through other information in the data structure 800. The one or more task requests 830 may be included within the health status data structure 820 and is described in more detail below.

The status ID 821 uniquely specifies a particular status and may include, for example, a user generated status name or a unique identification number assigned by a host 710. The date assigned 824 includes the date which the user specified the health status or a date which the user specifies as when the altered health status first occurred. The responsible user 826 includes a name or user ID of another user believed to be responsible for the health status. The user may manually specify another user to populate the data pertaining to the responsible user 826. In another implementation, the host 710 may assign or suggest other users as the responsible users through consideration of the health statuses of user identified by the associated users data 818 within the user profile data structure 810. In particular, the host 710 may analyze the health status data structures 820 within the user profile data structure 800 of users identified by the associated users 818 to determine which users previously have identified a similar health status or have indicated a similar status type 828. The host 710 may then assign or suggest other users identified as previously indicated similar health statuses as responsible users. The status type 828 specifies a particular health status and may specify a status from among a group of statuses. In particular, the status ID 821 may specify an ID value from a set of predetermined ID values which is associated with a particular common ailment (e.g., a cold).

The health task data structure 830 can include stored information about a health task and includes data pertaining to one or more health tasks. The health status data structure may be created when a user indicates an altered health status. For example, referring to the GUI 100 of FIG. 1, when the user requests a task through the request favor input option 140, a controlling host system 710 may create a structure to be stored within (or have its location pointed to) the user's user profile data structure 810 or health status data structure 820. FIG. 8 illustrates one example of the data structure 800 of FIG. 8 with two health tasks generated.

The health task data structure 830 include a task ID 830a and 830b, a task type 832a and 832b, as assigned user 834a and 834b, a date assigned 836a and 836b, and a due date 838a and 838b. The task ID 831a and 831b uniquely specifies a particular task and may include, for example, a user generated task name or a unique identification number. The task type 832a and 832b may specify an ID value from a set of predetermined ID values which is associated with a particular common task (e.g., bring over medicine). The assigned user 834a and 834b identifies the user to whom the health task is assigned and may include a user ID of the user. The date assigned 836a and 836b includes the date which the user identified by the assigned user 834a or 834b was specified or assigned the health task of the health task data structure 830. For example, date assigned 836a and 836b may be the day which the assigned-to user interacted with the user's profile to accept the health task as the assigned-to user's responsibility. The due date 838a and 838b is the date the health task is intended to be completed by and may be manually entered by either the user requesting the task or the user accepting responsibility for the task.

In one implementation, the due date 838a and 838b is automatically generated by the host 710 upon task acceptance by setting a time period (e.g., two days) from task acceptance. The host 710 may create additional functionality to assist in the fulfillment of the health task. For example, the host 710 may create a reminder (e.g., an Outlook® reminder) and e-mail the reminder to a user.

The data structure 800 is an example of information that may be stored in carrying out the techniques described in this disclosure. Various implementations may include different or additional data fields. For example, in one implementation, the data pertaining to the date assigned 824 of the health status data structure 820 is replaced with health status history data (not shown) which specifies the history of the health status. In particular, the health status history data includes an indication of previous health statuses of other users which are related by assigned responsibility. Therefore, the health status can be traced back to previous users based on the health status history data so that a cold, for example, can be traced backwards from associated users based on its assigned responsibility. When a user viewing the user's profile submits a request to view the health status history, the host 710 provides a GUI rendering the history of the health status and identifying previous users assigned the health status and the accompanying (if any) user's designated responsible for each health status.

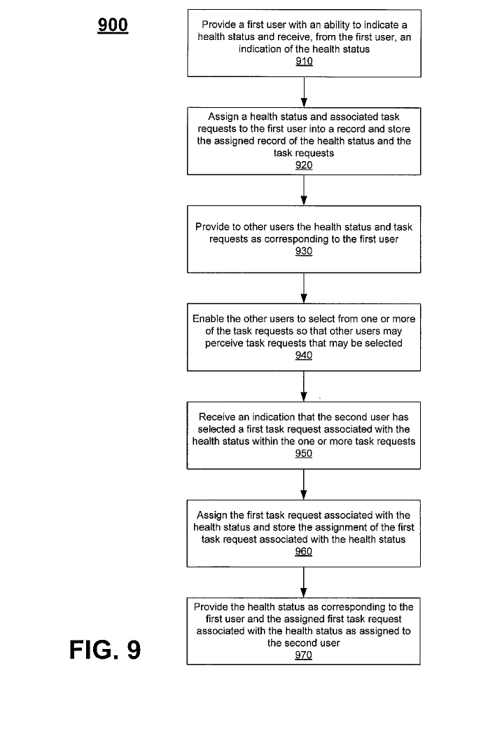

FIG. 9 is an exemplary flow chart of a process 900 for providing health status functionality. The process 900 of FIG. 9 provides task requests associated with a health status of a user such that the task requests may be assigned to one or more other users and can be implemented using the elements of the system 700 of FIG. 7 or other elements. In one implementation, the process 700 is implemented on the host 710.

The process 900 begins by providing a first user with an ability to indicate a health status and receiving, from the first user, an indication of the health status (910). For example, a user accessing a website of a social network may login with a username and password to access user profiles. The host running the website may, based on receipt of the username and password, provide a website to by rendered by the user's web-browser including interactive features which enable the user to indicate a health status. The host then assigns a health status and associated task requests to the first user into a record based on the received indication from the first user and stores the assigned record of the health status and the task requests (920). For example, the host may add a data object including the indicated health status and related information to stored profile data pertaining to the user, such as, for example, the user profile data structure 800 of FIG. 8.

Next, the host provides to other users the health status and task requests as corresponding to the first user (930) and enables the other users to select from one or more of the task requests so that other users may perceive task requests that may be selected (940). In particular, the host may provide, through a website, one or more GUIs enabling the other users to view the health status and task requests such the, for example, the GUIs 100-6000 of FIGS. 1-6. The health status and task request may be viewed individually or together within a user profile of the social networking site. By interacting with the website, the other users may perceive the various task requests that may be selected and may select a particular task request for assignment. Then, the host receives an indication that the second user has selected a first task request associated with the health status within the one or more task requests from a second user within the other users (950).

Upon receipt of the indication from the second user, the host assigns the first task request associated with the health status and stores the assignment of the first task request associated with the health status (960). For example, the host may add a data object including the first task request associated with the health status or edit an existing data object indicating the health status and related information in stored profile data pertaining to the user to also reference the assignment of the first task request. Finally, the host provides, to the other users, the health status as corresponding to the first user and the assigned first task request associated with the health status as assigned to the second user (970). The host may provide, through the website, one or more GUIs enabling the other users to view the health status as corresponding to the first user and the first task request as assigned to the second user. For example, a third user viewing a website rendering a GUI of the first user's profile may be rendered an indication that the first user currently suffers from the corresponding health status and that a first task request requested by the first user to help recovery from the ailment among multiple task requests is assigned to a second user.

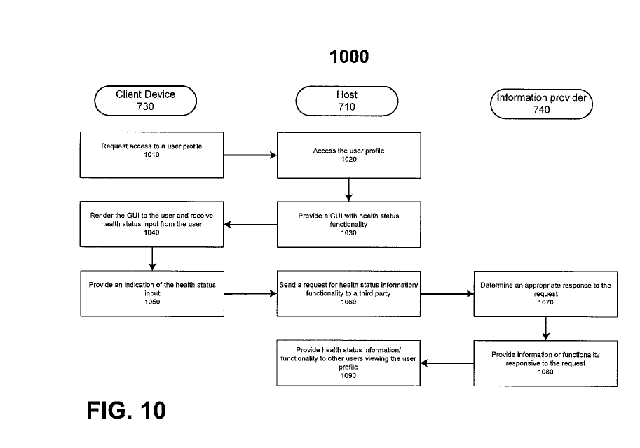

FIG. 10 is an exemplary flow chart of a process 1000 for providing health status functionality using third party information providers. As shown, FIG. 10 illustrates interaction between a client device 730, the host 710, and an information provider 740 of the system 700 of FIG. 7. The reference to the elements of FIG. 7 is exemplary and various implementations may conduct parts of the process 1000 differently. For example, in one implementation, steps 1070 and 1080 are conducted within the host 710 itself and the information provider 740 is not utilized.

The process 1000 begins when the client device 730 requests access to a user profile (1010). In particular, the client device 730 may login to a social networking site offered by the host 710 on the Internet. The client device 730 may enter a user name and password which may be associated with the user ID 811 of the user profile data structure 810 of FIG. 8. The host 710 receives the request and accesses the profile associated with the user of the client device 730 (1020). In accessing the profile, the host 710 may access the user profile data structure 810. Then, the host 710 provides a GUI with health status functionality to the client device 730 (1030). The GUI may be one or more of the GUIs 100-600 or may include functionality within the GUIs 100-600 of FIGS. 1-6. In one implementation, the host 710 provides HTML data of a website to the client device 730 to enable the client to render a website.

After receiving the data from the host 710, the client device 730 renders the GUI and receives health status input in the GUI from the user (1040). For example, a user on the client device 730 may enter or update a health status through use of the health status input option 120 described with respect to the GUI 100 of FIG. 1. Moreover, the rendered GUI may be a website rendered within a web-browser and the health status input from the user may be the result of interaction with HTML or JavaScript® generated functionality of the website. The client device 730 then provides an indication of the health status input to the host 710 (1050).

Upon receipt of the indication of the health status input, the host 710 may update the user profile data structure 810 by generating a health status data structure 820. The host 710 sends a request for health status information and/or functionality to third party (1060). In one implementation, the host 710 sends the request based upon requested functionality input by the user (e.g., selection of an option for additional information regarding a health status). In another implementation, the host 710 sends the request based on a prompt from the user. The third party (the information provider 740) receives the request and determines an appropriate response (1070). The third party then provides the appropriate response including information or functionality to the host 710 (1080). The host then provides the health status and the information and/or functionality provided by the information provider 740 to users viewing the user profile (1090). The host 710 receives the information or functionality and may incorporate all or part of it into the user's profile. For example, the host 710 may include an article about a specified health status provided by the information provider 740 in the user's profile such that other users accessing the user's profile are able to view the health status along with the provided article. The information provider's 740 response to the request for information and/or functionality may include, for example, medical news, articles, advice, links to websites or web-based forums, mapping information of healthcare providers, or other functionality, such as an ability to generate an electronic get well card.

In a more particular example, the user at the client device 730 requests more information about a health status when entering the health status in the rendered GUI (1040), through, for example, checking a box on the GUI. Then, the client device 730 provides the indication of the entered health status to the host 710 (1050), the client device 730 also includes an indication that the user requested more information. This indication that the user requested more information triggers the host 710 to send the request for further information to the third party (1060). When sending the request for further information to the third party, the host 710 may also include relevant context information, such as, for example, the health status and data from the user's user profile data structure 810. The information provider may tailor the appropriate response based upon consideration of the context information. For example, if the health status is “joint pain,” a medical information database configured as an information provider 740 may tailor a response to requested information and/or functionality related a user over the age of 40 as an article focused upon arthritis. If the request for information and/or functionality is related to a user under the age of 40, the information provider may response with provided an article focused upon pain medicine.

A process including these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language or in assembly or machine language if desired; and in any case, the language may be a compiled or interpreted language.

Suitable processors include, by way of example, both general and special purpose microprocessors. Generally, a processor receives instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; Digital Video Disk (DVD); and Compact Disc Read-Only Memory (CD-ROM). Any of the foregoing may be supplemented by, or incorporated in, specially-designed application-specific integrated circuits (ASICs).

Various modifications may be made. For example, useful results still may be achieved if steps of the disclosed techniques are performed in a different order and/or if components in the disclosed systems are combined in a different manner and/or replaced or supplemented by other components.

What is claimed is:

1. A computer-implemented method for enabling a user of a social networking website to present, to other users, a health status and multiple task requests such that another user may select a task request and view the selection of task requests of other users, the method comprising:
providing a first user accessing a social networking website over the Internet and through a web-browser with an ability to indicate a health status;
receiving, from the first user, an indication of the health status and a selection of multiple task requests to be associated with the health status;
updating, based on the received indication and selection from the first user, a profile of the first user within the social networking website stored in a user profile data structure to include the indicated health status and task requests;
providing, to other users accessing the social networking website over the Internet and through a web-browser, the profile of the first user as including the health status and task requests;
enabling the other users to select from one or more of the task requests so that other users may perceive task requests that have been assigned to users and to select an unassigned task request;
receiving, from a second user within the other users, an indication that the second user has selected a first task request associated with the health status within the one or more task requests;
assigning, based on the received indication from the second user, the first task request associated with the assigned health status to the second user;
updating the assignment of the first task request associated with the assigned health status as referenced within the user profile data structure; and
providing, to the other users associated with the first user accessing the first user's profile within the social networking website, the health status as assigned to the first user and the first task request associated with the assigned health status as assigned to the second user.

2. A computer-implemented method for providing task requests associated with a health status of a user such that the task requests may be assigned to one or more other users, the method comprising:
providing a first user with an ability to indicate a health status;
receiving, from the first user, an indication of the health status;
assigning, based on the received indication from the first user, a health status and associated task requests to the first user into a record;
storing the assigned record of the health status and the task requests;
providing, to other users, the health status and task requests as corresponding to the first user;
enabling the other users to select from one or more of the task requests so that other users may perceive task requests that may be selected;
receiving, from a second user within the other users, an indication that the second user has selected a first task request associated with the health status within the one or more task requests;
assigning, based on the received indication from the second user, the first task request associated with the health status;
storing the assignment of the first task request associated with the health status; and
providing, to the other users, the health status as corresponding to the first user and the assigned first task request associated with the health status as assigned to the second user.

3. The method of claim 1 wherein assigning the health status and associated task requests to the first user into a record includes assigning multiple task requests which each represent a portion of a predetermined plan of care for the health status into the record.

4. The method of claim 1 wherein providing the health status and task requests as corresponding to the first user includes providing, to other users viewing a social networking profile of the first user, the health status and task requests as features within the social networking profile of the first user.

5. The method of claim 4 wherein enabling the other users to allocate themselves one or more of the task requests includes enabling the other users viewing the social networking profile of the first user to view a populated list of task requests and select, from the populated list, one or more of the task requests for allocation.

6. The method of claim 4 wherein providing, the health status as corresponding to the first user and the assigned first task request associated with the health status as assigned to the second user includes providing, to the other users viewing a social networking profile of the first user, the health status as corresponding to the first user as a first feature within a first viewable portion of the social networking profile of the first user and the assigned first task request associated with the health status as assigned to the second user as a second feature within a second viewable portion of the social networking profile of the first user.

7. The method of claim 6 wherein providing, the health status as corresponding to the first user and the assigned first task request associated with the health status as assigned to the second user includes providing, to other users viewing a social networking profile of the second user, the assigned first task request associated with the health status as assigned to the second user as a feature with the social networking profile of the second user.

8. The method of claim 2 further comprising:
providing the first user the ability to indicate one or more task requests associated with the indicated health status, wherein
receiving the indication of the health status includes receiving, from the first user, the indication of the health status and the indication of the one or more task requests associated with the health status.

9. The method of claim 8 wherein receiving the indication of one or more task requests associated with the health status consists of receiving the indication of one or more task requests concurrently with or after receiving the indication of the health status.

10. The method of claim 8 wherein receiving the indication of the one or more task requests associated with the health status includes receiving the indication of the one or more task requests concurrently with and assigned to the indication of the health status.

11. The method of claim 2 wherein providing the first user with the ability to indicate the health status includes providing, as functionality to a user of a social networking website, the ability to indicate the health status to be associated with the likeness of the first user within the social networking website.

12. The method of claim 2 wherein assigning task requests to the first user includes determining that the one or more task requests should be assigned to the first user based on the indicated health status.

13. The method of claim 2 wherein assigning task requests to the first user includes determining that the one or more task requests should be assigned to the first user based on one or more aspects of a first user's profile other than health status.

14. A computer-readable medium encoded with a computer program comprising instructions that, when executed, operate to cause a computer to perform operations providing task requests associated with a health status of a user such that the task requests may be assigned to one or more other users, the computer program configured to:
provide a first user with an ability to indicate a health status;
receive, from the first user, an indication of the health status;
assign, based on the received indication from the first user, a health status and associated task requests to the first user into a record;
store the assigned record of the health status and the task requests;
provide, to other users, the health status and task requests as corresponding to the first user;
enable the other users to select from one or more of the task requests so that other users may perceive task requests that may be selected;
receive, from a second user within the other users, an indication that the second user has selected a first task request associated with the health status within the one or more task requests;
assign, based on the received indication from the second user, the first task request associated with the health status;
store the assignment of the first task request associated with the health status; and
provide, to the other users, the health status as corresponding to the first user and the assigned first task request associated with the health status as assigned to the second user.

15. The medium of claim 14 wherein assigning the health status and associated task requests to the first user into a record includes assigning multiple task requests which each represent a portion of a predetermined plan of care for the health status into the record.

16. The medium of claim 14 wherein providing the health status and task requests as corresponding to the first user includes providing, to other users viewing a social networking profile of the first user, the health status and task requests as features within the social networking profile of the first user.

17. The medium of claim 16 wherein enabling the other users to allocate themselves one or more of the task requests includes enabling the other users viewing the social networking profile of the first user to view a populated list of task requests and select, from the populated list, one or more of the task requests for allocation.

18. The medium of claim 16 wherein providing, the health status as corresponding to the first user and the assigned first task request associated with the health status as assigned to the second user includes providing, to the other users viewing a social networking profile of the first user, the health status as corresponding to the first user as a first feature within a first viewable portion of the social networking profile of the first user and the assigned first task request associated with the health status as assigned to the second user as a second feature within a second viewable portion of the social networking profile of the first user.

19. The medium of claim 18 wherein providing, the health status as corresponding to the first user and the assigned first task request associated with the health status as assigned to the second user includes providing, to other users viewing a social networking profile of the second user, the assigned first task request associated with the health status as assigned to the second user as a feature with the social networking profile of the second user.

20. The medium of claim 14 further comprising:
providing the first user the ability to indicate one or more task requests associated with the indicated health status, wherein
receiving the indication of the health status includes receiving, from the first user, the indication of the health status and the indication of the one or more task requests associated with the health status.

21. The medium of claim 20 wherein receiving the indication of one or more task requests associated with the health status consists of receiving the indication of one or more task requests concurrently with or after receiving the indication of the health status.

22. The medium of claim 20 wherein receiving the indication of the one or more task requests associated with the health status includes receiving the indication of the one or more task requests concurrently with and assigned to the indication of the health status.

23. The medium of claim 14 wherein receiving the indication of the one or more task requests associated with the health status includes receiving the indication of the one or more task requests concurrently with and assigned to the indication of the health status.

24. The medium of claim 14 wherein assigning task requests to the first user includes determining that the one or more task requests should be assigned to the first user based on the indicated health status.

25. The medium of claim 14 wherein assigning task requests to the first user includes determining that the one or more task requests should be assigned to the first user based on one or more aspects of a first user's profile other than health status.
